(19) United States
(12) Patent Application Publication
(10) Pub. No.: US 2015/0207961 A1
(43) Pub. Date: Jul. 23, 2015

(54) Automated dynamic video capturing

(71) Applicant: James Albert Gavney, JR., San Mateo, CA (US)

(72) Inventor: James Albert Gavney, JR., San Mateo, CA (US)

(21) Appl. No.: 13/999,935

(22) Filed: Apr. 4, 2014

Related U.S. Application Data
(60) Provisional application No. 61/964,900, filed on Jan. 17, 2014.
(60) Provisional application No. 61/965,508, filed on Feb. 3, 2014.
(60) Provisional application No. 61/966,027, filed on Feb. 14, 2014.

(51) Int. Cl. H04N 5/14; H04N 7/14; H04N 9/04; H04N 5/225; H04N 5/232; G06K 9/32

(52) U.S. Cl. CPC H04N 5/147; H04N 5/23203; G06K 9/3233; G06K 9/3275; H04N 9/045; H04N 5/2258; H04N 7/147; G06K 2009/3291; G06K 2207/1016; G06K 2207/1017; G06K 2207/1013; G06K 2209/21; H04N 2209/048

(57) ABSTRACT

A video system is disclosed that include a video robot. The video robot includes a video capturing device and a location sensing mechanism for sensing locations of a target within a space. The robot also include a mechanism for automatically selecting a field of view of the video capturing device to correspond to the locations of the subject as the subject moves through the locations in the space. In the method of the invention, locations of the target are monitored with a video capturing unit using location signals transmitted from a sensor on or near the target. Based on the locations of the target, the field of view of the video capturing unit to automatically adjusted to correspond to the locations of the subject as the subject moves through the space while the video unit simultaneously captures video data and displays representations of the video data on a screen.

### RELATED APPLICATION

This patent application claims priority under 35 U.S.C. 119(e) of the U.S. Provisional Patent Application Ser. No. 61/964,900 filed Jan. 17, 2014, and titled “SYSTEM FOR COLLECTING LIVE STREAM VIDEO DATA”, the U.S. Provisional Patent Application Ser. No. 61/965,508 filed Feb. 3, 2014, and titled “SYSTEM FOR COLLECTING LIVE STREAM VIDEO DATA OR RECORDING VIDEO DATA”, the U.S. Provisional Patent Application Ser. No. 61/966,027 filed Feb. 14, 2014, and titled “SYSTEM FOR COLLECTING LIVE STREAM VIDEO DATA OR RECORDING VIDEO DATA”. The U.S. Provisional Patent Application Ser. Nos. 61/964,900 filed Jan. 17, 2014, 61/965,508 filed Feb. 3, 2014, and 61/966,027 filed Feb. 14, 2014 are all hereby incorporated by reference.

### FIELD OF THE INVENTION

This invention relates video systems. More particularly, the present invention relates to a video system that tracks and follows a target to collect dynamic video data.

### BACKGROUND OF THE INVENTION

Digital communications has become common place due to the speed and ease that digital data and information can be transmitted between local and remote devices. Current digital communications systems, however, provide an impersonal and static interactive user experience.

On one end of the communication spectrum is “texting” that includes text messaging and e-mailing. Texting and emailing are impersonal and void of expression but do provide quick and easy ways to convey information. On the other end of the communication spectrum are “meetings” or face-to-face communications, that provide the most personal and expressive communication experience. However, meetings are not always convenient and in some cases are impossible. With the increased band width and transmission speed of networks (internet, intranet and local area networks) video communication has been increasingly filling the void between texting or e-mailing and meetings.

For example, there are now several services that provide live-stream videos through personal computers or cell phones. Internet accessible video files that are posted (stored) on remote servers have become a common place method for distributing information to large audiences. These video systems do allow for a greater amount of information to be disseminated and do allow for a more personal and interactive experience. However, these video systems still do not provide a dynamic video experience.

### SUMMARY OF THE INVENTION

Prior art video system include surveillance video systems, including drone surveillance systems, with static or pivoting video cameras operated remotely using a controller to document and record subjects or targets. Action video system, including hand-held cameras, head mounted cameras and/or other portable devices with video capabilities, are used by an operator to document and record subjects or targets. Also, most desk-top computer systems are now equipped with a video cameras or include the capability to attach a video camera. Some of these video systems that are currently available requires the operator follow or track subjects or targets by physically moving a video capturing device or by moving a video capturing device with a remote control. Other video systems require that the subject or target is placed in a fixed or static location in front of a viewing field of the video capturing device.

For the purpose of this application, the terms below are ascribed the following meaning:

1) Mirroring means that a two or more video screens are showing or displaying substantially the same representation of video data, usually originating from the same source.
2) Pushing is a process of transferring video data from one device to a video screen of another device.
3) Streaming means to display a representation of video data on a video screen from a video capturing device in real-time as the video data is being captured within the limits of data transfer speeds for a given system.
4) Recording means to temporarily or permanently store video data from a video capturing device on a memory device.

Preferably, the present invention is directed a video system that automatically follows or tracks a subject or target once the subject or target has been selected with a “hands-off” video capturing device. The system of the present invention seeks to expand the video experience by providing dynamic self-video capability. In the system of the present invention video data that is captured with a video capturing device is shared between remote users, live-streamed to or between remote users, pushed from a video capturing device to one or more remote or local video screens or televisions, mirrored from a video capturing device to one or more remote or local video screens or televisions, recorded or stored on a local memory device or remote server or any combination thereof.

System of the present invention includes a robotic pod for coupling to video capturing device, such a web-camera, a smart phone or any device with video capturing capabilities. The robotic pod and the video capturing devices are collectively referred to, herein, as a video robots or video units. The robotic pod includes a servo-motor or any other suitable drive mechanism for automatically moving a coupled video capturing device to collect video data corresponding to dynamic or changing locations of a subject, object or person (hereafter, target) as the target moves through a space, such as a room. In other words, the system automatically changes the viewing field of the video capturing device by physically moving the video capturing device, or portion thereof, (lens) to new positions in order to capture video data of the target as the target moves through the space.

In some embodiments of the invention a base portion of the robotic pod remains substantially stationary and the drive mechanism moves or rotates the video device and/or its corresponding lens. In other embodiments of the invention the robotic pod is also configured to move or rotate. Regardless of how the video capturing device follows the target, the system includes sensor technology for sensing locations of the target within a space and then causes or instructs the video capturing device to collect video data corresponding the locations of the target within that space. Preferably, the system is capable of following the target, such that the target is within viewing field of the video capturing device with an error of 30 degree or less of the center of the viewing field of the video capturing device.

In accordance with the embodiments of the invention, the sensor technology (one or more sensors, one or more micro-processors and corresponding software) lock onto and/or identifies target being videoed and automatically tracks the video capturing device to follow the motions or movements of the target with the viewing field of the video capturing device as the target moves through the space. For example, the robotic pod includes a receiving sensor and the target is equipped with, carries or wears a device with a transmitting sensor. The transmitting sensor can be any sensor in a smart phone, in a clip on device, in a smart watch, in a remote control device, in a heads-up display (i.e Google Glasses) or in a Blue-Tooth head set, to name a few. The transmitting sensor or sensors and the receiving sensor or sensors are radio sensors, short-wavelength microwave device (Blue-Tooth) sensors, infrared sensors, acoustic sensor, optical sensor, radio frequency identification device (RFIDs) sensors or any other suitable sensors or combination of sensors that allow the system to track the target and move or adjust the field of view of the video capturing device, for example, via the robotic pod, to collect dynamic video data as target moves through a space.

The sensor technology in hosted in the robotic pod, the video capturing device, an external sensing unit and/or combinations thereof. Preferably, the video capturing device includes a video screen for displaying the video data being collected by the video capturing device and/or other video data transmitted, for example, over the interne. In addition the system is configured to transmit and display (push and/or mirror) the video data being collected to a peripheral screen, such as a flat screen TV monitor or computer monitor using, for example, a wireless transmitter and receiver (Wi-Fi). The system of the present invention is particularly well suited for automated capturing of short range, within 50 meters, video of a target within a mobile viewing field of the video capturing device. The system is capable of being adapted to collect dynamic video data from any suitable video capturing device including, but not limited to, a video camera, a smart phone, web camera and a head mounted camera.

### DESCRIPTION OF DRAWINGS

FIG. 1 shows a video system with a video robot, in accordance with the embodiments of the invention.

FIG. 2A shows a video system with a video robot that tracks a target, in accordance with the embodiments of the invention.

FIG. 2B shows a video system with multiple mobile location sensors or targets that are capable of being activate and deactivated to control a field of view of a video robot, in accordance with the embodiments of the invention.

FIG. 3 shows a video system with a video robot and a video and/or audio headset, in accordance with the embodiments of the invention.

FIG. 4 shows a video capturing unit with multiple video cameras, in accordance with the embodiments of the invention.

FIG. 5 shows a sensor unit with an array of sensors for projecting, generating or sensing a target within a two-dimensional or three-dimensional sensing field or sensing grid, in accordance with the embodiments of the invention.

FIG. 6 shows a representation of a large area sensor with sensing quadrants, in accordance with the embodiments of the invention.

FIG. 7 shows a representation of a video system with a multiple video units, in accordance with the embodiments of the invention.

FIG. 8 shows a video system with a video display device or a television with a camera and a sensor for tracking a target, capturing video data of the target and displaying a representation of the video data, in accordance with the embodiments of the invention.

FIG. 9 shows a video system with a video robot, a head mounted camera and a display, in accordance with the embodiments of the invention.

FIG. 10 shows a representation of a video system that include a video capturing device that pushes video data to one or more selected video screens or televisions through one or more wireless receivers, in accordance with the embodiments of the invention.

FIG. 11 shows a block flow diagram of the step for capturing and displaying video data corresponding to dynamic or changing locations of a target as the target moves through a space, in accordance with the method of the invention.

### DETAILED DESCRIPTION OF THE INVENTION

The video system 100 of the present invention includes a video capturing device 101 that is coupled to a robotic pod 103 (video robot 102) through, for example, a cradle. In accordance with the embodiments of the invention, the robot pod 103 is configured to power and/or charge the video capturing device 101 through a battery 109 and/or a power chord 107. The robotic pod 103 includes a servo-motor or stepper motor 119 for rotating or moving the video capturing device 101, or portion thereof, in a circular motion represented by the arrow 131 and/or move in any direction as indicated by the arrows 133, such that the viewing field of the video capturing device 101 follows a target 113′ as the target 113′ moves through a space. The robotic pod 103 includes, for example, wheels 139 and 139′ that move the robot pod 103 and the video capturing device 101 along a surface and/or a servo-motor or stepper motor 119 moves the video capturing device 101 while the robotic pod 103 remains stationary.

The robotic pod 103 includes a receiving sensor 113 for communicating with a target 113′ and a micro-processor with memory 117 programmed with software configured to instruct the servo-motor 119 to move the video capturing device 101, and/or portion thereof, to track and follow locations of the target 113′ being videoed. The video capturing device 101 includes, for example, a smart phone with a screen 125 for displaying a representation of video data being captured by the video capturing device 101. The video capturing device 101 includes at least one camera 121 and can also include additional sensors 123 and/or software for instructing the server motor or stepper motor 113 where to position and re-position the video capturing device 101, such that the target 113′ remains in a field of view of the video capturing device 101 as the target 113′ moves through the space.

In accordance with the embodiments of the invention the target 113′ includes a transmitting sensor that sends positioning or location signals 115 to the receiving sensor 113 and updates the micro-processor 117 of the current location of the target 113′ being videoed by the video capturing device 101. The target 113′ can also include a remote control for controlling the video capturing device 101 to change a position and/or size of the field of view (zoom in and zoom out) of the video capturing device 101.

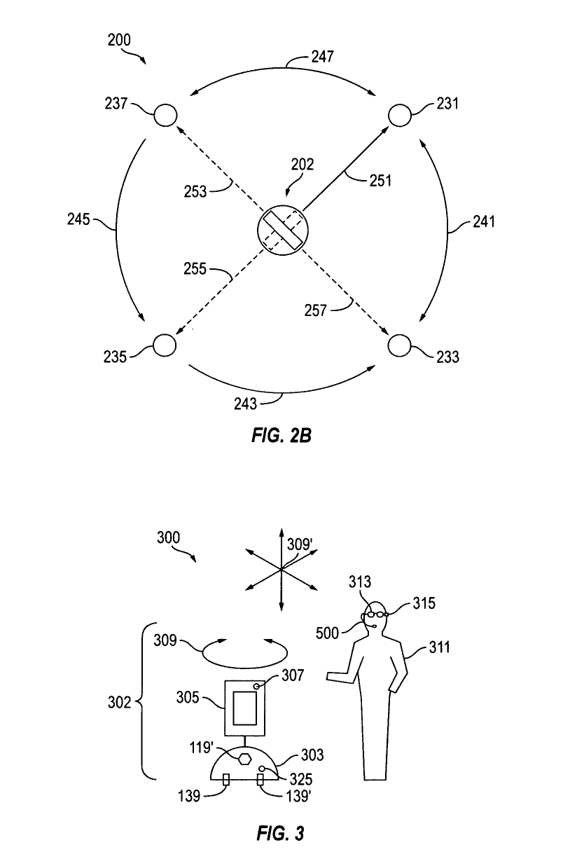

Referring to FIG. 2A, in operation the subject 113′ is, for example, a sensor pin or remote control, as described above, that is attached to, worn on and/or held by a person 141. As the person 141 moves around in a space, as indicated by the arrows 131′ and the arrows 133′ and 133″, the video robot 102, or portion thereof, follows the target 131′ and captures dynamic video data of the person 141. The video data is live-streamed from the video capturing device 101 to a periphery display device and/or is recorded and stored in the memory of the video capturing device 101 or any other device that is receiving the video data. The video robot 102 sits, for example, on a table 201 or any other suitable surface and moves in any number of directions 131′ 133′ and 133″, such as described above, on a surface of the table 201.

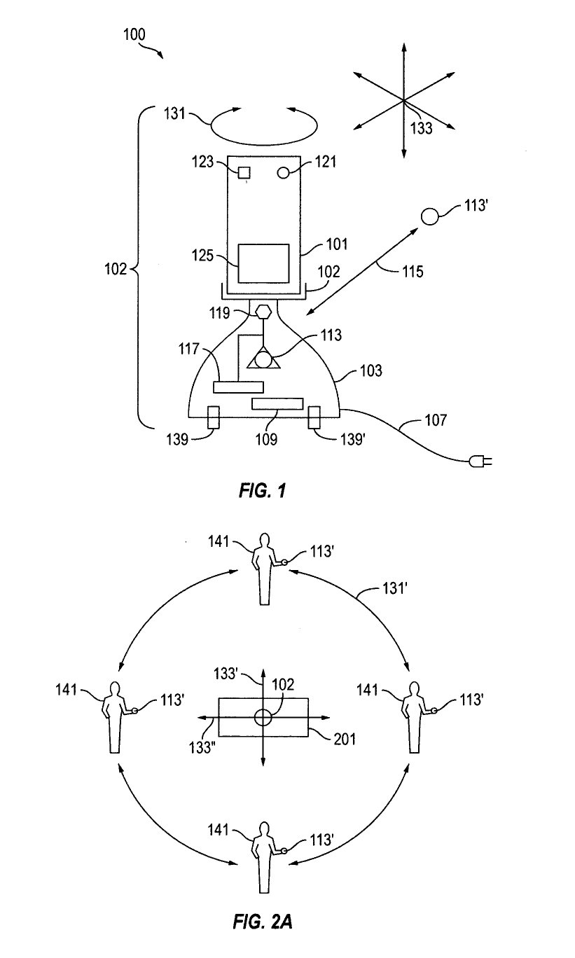

In further embodiments of the invention the video system 100 (FIG. 1) can include multiple targets and/or include multiple mobile transmitting sensors (mobile location sensors) that are turned on and off, or otherwise controlled, to allow the video robot 102 to switch back and forth between the targets or focus on portions of the targets, such as described below.

FIG. 2B shows a video system 200 with multiple mobile location sensors or targets 231, 233, 235 and 237 that are capable of being activate and deactivated to control a field of view of a video capturing unit or device, represented by the arrows 251, 253, 255 and 257 on a video robot 202, similar to the video robot 102 described with reference to FIGS. 1 and 2A. By selectively activating and deactivating the mobile location sensors 231, 233, 235 and 237, the video robot 202 will rotate, move or reposition, as indicated by the arrows 241, 243, 245 and 247 to have the activated mobile location sensors in the field of view of the video robot 202. The mobile location sensors can be equipped with controls to move the video robot 202 to a preferred distance, focus and/or zoom the field of view of the video capturing unit or device on the video robot 202 in and out.

Referring now to FIG. 3, a video system 300 of the present invention includes a video robot 302 with a robotic pod 303 and a video capturing device 305, such as described with reference to FIGS. 1, 2A and 2B. Preferably, the robotic pod 303 includes a sensor 325 (transmitting and/or receiving), a mechanism 119′ to move the video capturing device 305 with a camera 307 (or portion thereof), a micro-processor with memory, a power source and any other necessary electrical connections (not shown). The mechanism 119′ to move the video capturing device 305 with the camera 307, includes a servo-motor or stepper motor 119′ that engages wheels 139 and 139′ or gears to move the entire video capturing unit 301, the video capturing device 305 or any portion thereof, such as described above. In operation, the robotic pod 301 moves the video capturing device 305, or portion thereof, in any number of directions represented by the arrows 309 and 309′, in order to keep a moving target within a field of view of the camera 307.

Still referring to FIG. 3, as described above, a person or subject 311 wears or carries one or more transmitting sensor devices (transmitting and/or receiving) that communicates location signals to one or more sensors 325 on the robotic pod 303 and/or video capturing device 305 and the micro-processor instructs the mechanism 119′ to move the video capturing device 305, lens of the camera 307 or any suitable portion of the video capturing device 305 to follow the person or subject 311 and keep the person or subject 311 in a field of view of the video capturing device 305, as the person or subject 311 moves through a space. The one or more transmitting sensor devices include, for example, an Blue-Tooth head-set 500 with ear-phone and a mouth speaker and/or a heads-up display 315 attached to a set of eye glasses 313. Where the one or more transmitting sensor devices include a heads-up display 315, the 311 person is capable of viewing video data received by and/or captured by the video capturing device 305 even when person's back facing the video capturing device 305.

In operation multiple user's are capable of video conferencing while moving and each user is capable of seeing the other users even with their backs are facing their respective video capturing devices. Also, because the head-sets 500 and/or heads-up displays 315 transmit sound directly to an ear of each user and receives voice data through a micro-phone near the mouth of each user, the audio portion of the video data streamed, transmitted, received or recorded remains substantially constant as users move around during the video conferencing.

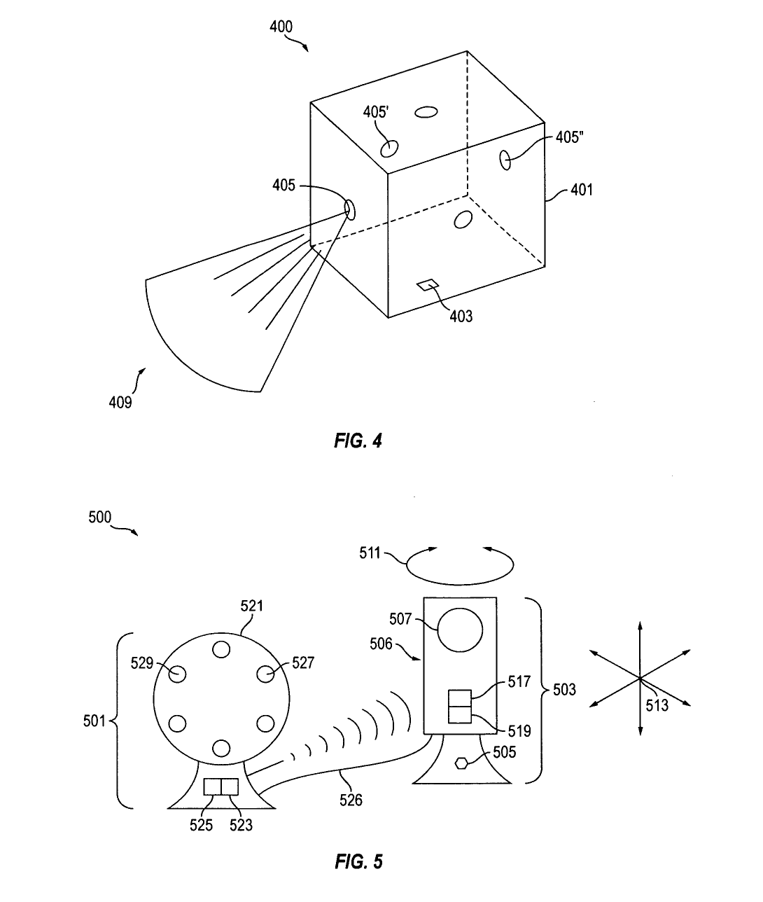

Now referring to FIG. 4, in yet further embodiments of the invention a video capturing unit 401 a video system 400 has any number or geometric shapes. The video capturing unit 401 includes multiple video cameras 405, 405′ and 405″. The video capturing unit 401 includes a sensor (transmitting and/or receiving), a micro-processor, a power source any other necessary electrical connections, represented by the box 403. Each of the video cameras 405, 405′ and 405″ has a field of view 409. In operation the video capturing unit 400 tracks were target is in a space around the video capturing unit 401 using the sensor and turns on, controls or selects the appropriate video camera from the multiple video cameras 405, 405′ and 405″ to keep streaming, transmitting, receiving or recording video data of the target as the target through a space around the video capturing unit 400. The video capturing unit 401 moves, such as described with reference to the video robot 102 (FIG. 1), or remains stationary.

Now referring to FIG. 5, a video system 500 includes a sensor unit 501 that has any number or geometric shapes. For example the sensor unit 501 has a sensor portion 521 that is sphere, a cylinder, a dodecahedron or any other shape. The sensor portion 521 includes an array of sensors 527 and 529 that project, generate or sense a two-dimensional or three-dimensional sensing field or sensing grid that emulates outward from the sensor unit 501. The sensors are CCD (charge coupled device), CMOS (complementary metal oxide semiconductor) sensors, infrared sensors, or any other type of sensors and combinations of sensors. The sensor unit 501 also includes a processor unit 525 with memory that computes and stores location data within the sensing field or sensing grid based on which of the sensors within the array of sensors 527 and 529 are activated by a target as the target moves through the two-dimensional or three-dimensional sensing field or sensing grid. The sensor unit 501 also includes a wireless transmitter 523 or a chord 526 for transmitting the location data, location signals or version thereof to a video capturing unit 503. The sensor unit 501 moves, such as described above with reference to the video robot 102 (FIG. 1), or remains stationary.

The video capturing unit 503 includes a housing 506, a camera 507 and a servo-motor 505, a processor unit (computer) 519 with memory and a receiver 517, such as described above. In operation, the sensing unit 501 transmits location data, location signals or version thereof to the video capturing unit 503 via the transmitter 523 or chord 526. The receiver 517 receives the location data, location signals or version thereof and communicates the location data or location signals, or a version thereof, to the processor unit 519. The processor unit 519 instructs the servo-motor 505 to move a field of view of the camera 507 in any number of directions, represented by the arrows 511 and 513, such that the target remains within the field of view of the camera 507 as the target moves through the two-dimensional or three-dimensional sensing field or sensing grid. In accordance with the embodiments of the invention any portion of the software to operated the video capturing unit 503 is supported or hosted by the processor unit 525 of the sensing unit 501 or the processing unit 519 of the video capturing unit 503.

Also, as described above, the housing 506 of the video capturing unit 503 is moved by the servo-motor 505, the camera 507 is moved by the servo-motor 505 or a lens of the camera 507 is moved by the servo-motor 505. In any case, the field of view of the video capturing unit 503 adjusts to remain on and/or stay in focus with the target. It also should be noted that the video system 500 of the present invention can include auto-focus features and auto calibration features the allows the video system 500 to run an initial set-up mode to calibrate starting locations of the sensor unit 501, the video capturing unit 503 and the target that is being videoed. The video data captured by the video capturing unit 503 is live-streamed to or between remote users, pushed from the video capturing unit 503 to one or more remote or local video screens or televisions, mirrored from video capturing unit 503 to one or more remote or local video screens or televisions, recorded and stored in a remote memory device or the memory of the processor unit 525 of the sensing unit 501 or the memory of the processing unit 519 of the video capturing unit 503, or any combination thereof.

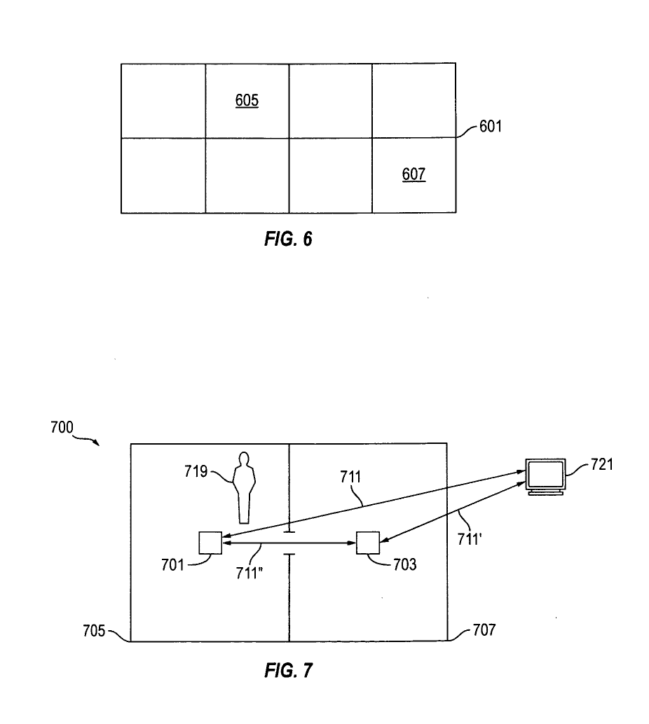

Now referring to FIG. 6, in accordance with the embodiments of the invention any one of the video systems described above includes a continuous larger area sensor 601. The large area sensor 601 has sensing quadrants or cells 605 and 607. Depending on which of the quadrants or cells 605 and 607 are most activated by a target, the video system adjusts a video capturing device 101 (FIG. 1) or video capturing unit 501 (FIG. 5) to keep a target within the field of view of the video capturing device 101 or video capturing unit 501, such as described above.

FIG. 7 shows a system 700 of the present invention that includes plurality of video units 701 and 703. The video units 701 and 703 include a sensor unit and a video capturing unit, such as described in detail with reference to FIGS. 1 and 5. In operation the video units 701 and 703 communicate with a video display 721, such as a computer screen or television screen and as indicated by the arrows 711 and 711′ in order to display representations of video data being captured by the video units 701 and 703. The video units 701 and 703 sense locations of a target or person 719 as the target or person 719 moves between rooms 705 and 707 and video capturing is handed off between the video units 701 and 703 as indicated by the arrow 711″. Accordingly, the video unit 701 or 703 that is in the best location to capture the video data of the target controls steaming, pushing or mirroring of representations of the video data that are displayed on the video display 721. Again, the location of the target or person 719 can be determined or estimate using a projected sensor area, such as described with reference to FIG. 6, a sensor array such as described with reference to FIG. 5, a transmitting sensor, such as decided with reference to FIGS. 1-3 and/or pattern recognition software operating from the video units 701 and 703.

For example, the video units 701 and 703 use a continuous auto focus feature and/or recognition software to lock onto a target and the video units 701 and 703 include a mechanism for moving itself, a camera or a portion thereof to keep the target in the field of view of video units 710 and 703. In operation, the video units 701 and 703 take an initial image and based on an analysis of the initial image, a processor unit coupled to video units 701 and 703 then determines a set of identifiers. The processor unit in combination with a sensor (which can be an imaging sensor of the camera) then uses these identifiers to move the field of view of the video capturing units of the video units 701 and 703 to follow the target as the target moves through a space or between the rooms 705 and 707. Alternatively, or in addition to computing identifiers and using identifiers to follow the target, the processor unit of the video units 701 and 707 continuously samples portions of the video data stream and based on comparisons of the samples, adjusts the field of view of the video capturing units, such that target stays within the field of view of the video capturing units as the target move through the space or between the rooms 705 and 707.

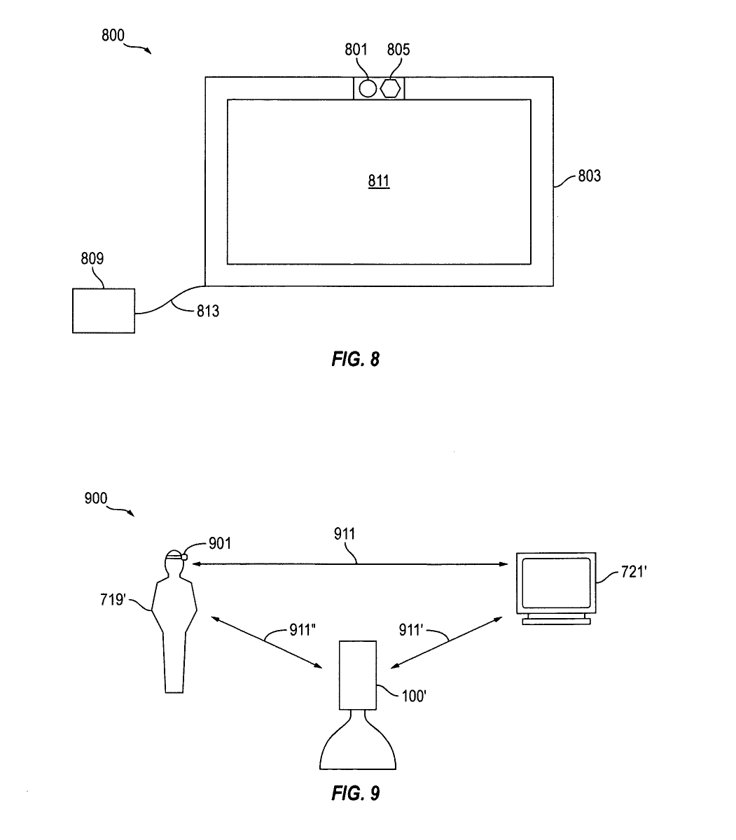

FIG. 8 shows video system 800 with a video display device or a television 803 having a camera 801 and a sensor 805 for tracking a target and capturing video data of a target, receptively, and displaying representations of the video data on a screen 811. In accordance with this embodiment of the invention, the sensor 805 alone or in combination with a transmitting sensor (not shown), such as describe with respect to FIGS. 1-3, locates the target and communicates locations of the target to the camera through a micro-processor with software. The micro-processor then adjusts a field of view of the camera 801 through, for example, a micro-controller to position and re-position the camera 801, or portion thereof, such that the target remains in a field of view of the camera 801 as the target moves through a space around the video system 800. The video system 800 also preferably includes a wireless transmitter and receiver 809 that is in communication with the video display device or a television 803 through, for example, a chord 813, and is capable of communicating with other local and/or remote video display devices to stream, push and/or mirror representations of the video data captured by the camera 801 or displayed on the screen 811 of the video display device or a television 803.

FIG. 9 shows a video system 900 with a head mounted camera 901, a video robot 100′ and a display unit 721′, in accordance with the embodiments of the invention. In operation a person 719′ wears the head mounted camera 901 and the head mounted camera 901 captures video data as the person 719′ moves through a space around the video system 900. The video data that is captured by the head mounted video camera 901 is transmitted to the display unit 721′ and/or the video robot 100′ as indicated by the arrows 911 and 911′ using any suitable means including, but not limited to, Wi-Fi to generate or display representations of the video data on the respective screens of the display unit 721′ and video robot 100′. The video robot 100′ includes a video capturing unit and a sensor unit, as described in detail with reference to FIGS. 1-3. The video robot 100′ tracks locations of the head mounted camera 901 and/or the person 719′ and captures dynamic video data of the person 719′ as the person 719′ move through the space around the video system 900. The video robot 100′ is also in communication with the display unit 721′ as indicated by the arrow 911′ using any suitable means including, but not limited to, Wi-Fi, to generate or display representations of the video data captured by the video robot 100′ on the screen of the display unit 721′. The video data captured by the video robot 100′ can also be displayed on a screen of the video robot 100′. The video data, or a representation thereof, can also be streamed from the head mounted camera 901 to the display unit 721′ and/or the video robot 100′ and pushed or mirrored between the video robot 100′ and the video display unit 721′.

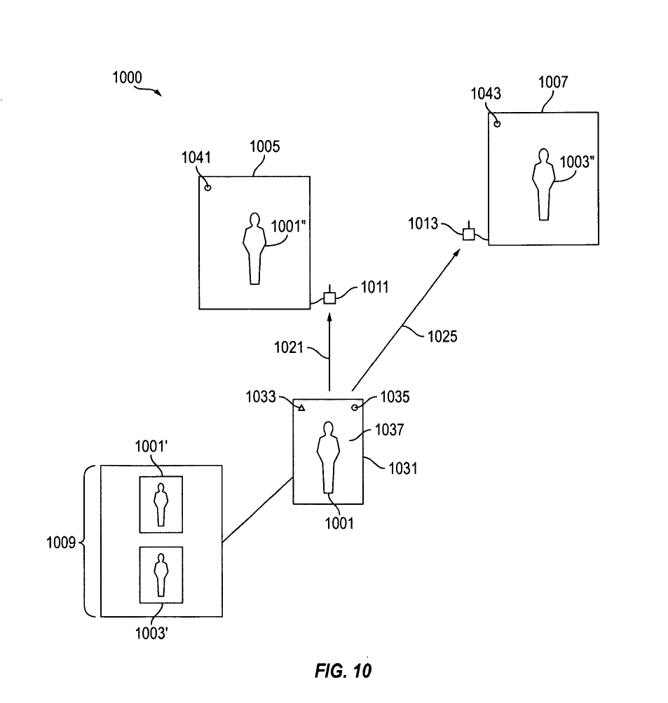

FIG. 10 shows a representation of a video system 1000 that includes a video capturing device 1031. The video capturing device 1031 is able to capture local video data and stream, push and/or mirror the video data to one or more selected video screens or televisions 1005 and 1007. The local video data is streamed, pushed and/or mirrored to the one or more selected video screens or televisions 1005 and 1007 through one or more wireless receivers 1011 and 1013, represented by the arrows 1021 and 1023. The one or more video screens or televisions 1005 and 1007 then display representations 1001″ and 1003″ of the video data.

In accordance with this embodiment, the video capturing device 1031 includes a wireless transmitter/receiver 1033 and a camera 1035 that for capturing the local video data and/or receiving video data transmitted for one or more video capturing devices at remote locations (not shown). Representations of video data 1001 of the video data captured and/or received by the video capturing device 1031 can also be displayed on a screen of the video capturing device 1031 and the images displayed on the one or more video screens 1005 and 107 can be mirrored images or partial image representations of the video data displayed 1001 on the screen of the video capturing device 1031.

Preferably, the video capturing device 1031 includes a user interface 1009 that is accessible from the screen of video capturing device 1031 or portion thereof, such that a user can select which of one or more video screens or televisions 1005 and 1007, represented by images 1001′ and 1003′, that the video data being captured or received by the video capturing device 1031 is displayed on. In further embodiments of the invention the one or more video screens or televisions 1005 and 1007 are equipped with a sensor or sensor technology 1041 and 1043, for example, image recognition technology, such that the sensor or sensor technology 1041 and 1043 senses locations of a the user and/or the video capturing device 1031 and displays representations of the video data captured and/or received by the video capturing device 1031 on the one or more video screens or televisions 1005 and 1007 corresponding to near by locations of the user and/or video capturing device 1031.

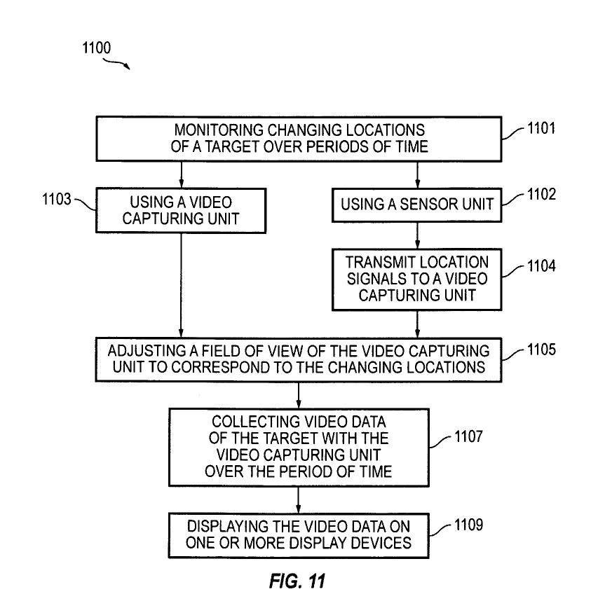

FIG. 11 shows a block flow diagram 1100 of the steps for capturing and displaying representations of video data corresponding to dynamic or changing locations of a target as the target moves through a space, in accordance with the method of the invention. In accordance with the method of the invention in the step 1101 locations of a target are monitored over a period of time. In the step 1103 the locations of the target are monitored directly from a video capturing unit using a sensor unit or alternatively the locations of the target are monitored using a sensor unit in combination with a transmitting sensor, such as described with reference to FIGS. 1-5 on or near the target in the step 1102. Locations of the target are communicated to or transmitted to the video capturing unit using a micro-processor programmed with software in the step 1104. Regardless of how the locations of the target are monitored, in the step 1105 a field of view of the video capturing unit is adjusted using a camera that is coupled to a micro-motor or micro-controller in order to correspond to the changing locations of the target over the period of time, such as described with reference to FIGS. 1-3 and 5. While adjusting the field of view of the video capturing unit in the step 1105, simultaneously in the step 1107 the video capturing unit collects, captures and/or records video data of the target over the period of time. While the video data is colleted, captured or recorded in the step 1107, in the step 1009 a representation of the video data is displayed on one or more display devices, such as described with reference to FIGS. 7-10.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

1. A system comprising
a) a video capturing unit for capturing video data;
b) a location sensing mechanism for sensing locations of a target within a space; and
c) a mechanism for automatically selecting a field of view of the video capturing unit to correspond to the locations of the target as the subject moves through the locations in the space while the video capturing unit is capturing the video data.

2. The system of claim 1, wherein the location sensing mechanism includes a transmitting location sensor that couples to the target.

3. The system of claim 1, wherein the location sensing mechanism includes a sensor unit with an array of sensors that project, generate or sense a two-dimensional or three-dimensional sensing field or sensing grid.

4. The system of claim 1, wherein the location sensing mechanism includes multiple mobile location sensors that are capable of being activate and deactivated to control the field of view of a video capturing unit.

5. The system of claim 1, wherein the video capturing unit includes multiple video cameras that are activated and deactivated to select the field of view.

6. The system of claim 1, further comprising a video display unit for displaying representations of the video data.

7. The system of claim 6, wherein the video capturing unit, the location sensing mechanism and the mechanism for automatically selecting a field of view of the video capturing unit are built into the video display.

8. The system of claim 1, further comprising a user interface for selecting video display units that display representations of the video data.

9. The system of claim 1, wherein the location sensing mechanism and the mechanism for automatically selecting a field of view of the video capturing unit are built into a robotic pod.

10. The system of claim 9, wherein the video capturing unit detachably couples to the robotic pod.

11. The system of claim 10, wherein the video capturing unit includes smart phone.

12. A method comprising:
a) monitoring locations of a target using location signals transmitted from a transmitting location sensor on or near the target:
b) a automatically selecting a field of view of a video capturing unit to correspond to the locations of the target as the subject target moves through a space around the video unit; and
c) capturing video data with the video capturing unit corresponding to the locations of the target.

13. A method comprising:
a) monitoring locations of a target with a sensing unit to generate location data:
b) automatically adjusting a field of view of a video capturing unit to correspond to the locations of the target as the subject moves through a space based on the location data; and
c) capturing video data with the video unit corresponding to the locations of the target.

14. The method of claim 12, wherein monitoring locations of a target includes receiving location signals with receiving sensor on the video capturing unit.

15. The method of claim 12, wherein monitoring locations of a target includes receiving location signals with a receiving sensor on a robotic pod coupled to the video capturing unit.

16. The method of claim 12, further comprising transmitting a representation of the video data to a remote device.

17. The method of claim 13, wherein the sensor unit includes a plurality of sensors that are activated and deactivated based on the locations of the target.

18. The method of claim 13, wherein the location data is transmitted to a robotic pod for automatically adjusting the field of view of the video capturing unit.

19. The method of claim 13, wherein the location data is transmitted to a receiving sensor of the video capturing unit for automatically adjusting the field of view of the video capturing unit.

20. The method of claim 13, further comprising transmitting a representation of the video data to a remote device.
